(19) United States
(12) Patent Application Publication
(10) Pub. No.: US 2006/0202552 A1
(43) Pub. Date: Sep. 14, 2006

(54) Electronic control method for a slip-controlled motor vehicle brake system

(75) Inventors: Guntjof Magel, Russelsheim (DE); Rudiger Mahlo, Berlin (DE); Frank Sikorski, Bad Hamburg (DE); Faouzi Attallah, Heinrichstr. (DE); Lukas Kroh, Butzbach (DE)

Correspondence Address: Gerlinde M Nattler;Craig Hallacher, Continental Teves Inc, One Continental Drive, Auburn Hills, MI, 48326, US

(73) Assignee: Continental Teves AG & Co.oHG, Frankfurt (DE)

(21) Appl. No.: 10/564,221

(22) PCT Filed: Jul. 8, 2004
(86) PCT No.: PCT/EP04/51414

§ 371 Date: Jan. 11, 2006

(30) Foreign Application Priority Data
Jul. 11, 2003 (DE) 103 31 781.3
Jul. 25, 2003 (DE) 103 34 355.5
Nov. 26, 2003 (DE) 103 55 239.1

(51) Int. Cl. B60T 8/56

(52) U.S. Cl. 303/142; 303/145; 303/10

(57) ABSTRACT

Disclosed is an electronic control method for a slip-controlled motor vehicle brake system (1), featuring a distributor device (5) with an electronic unit (7,ECU) and hydraulic unit (6,HCU) having a housing body for hydraulic components, such as electrohydraulic inlet and outlet valves (9,10) for wheel brakes (8) organized in brake circuits, and with a motor-pump-aggregate with an electric motor (15) for redirecting hydraulic fluid from wheel brakes (8) in the direction of a pressure sensor (3). Antilock control is facilitated through the build-up, maintenance and release of pressure in the electrohydraulic inlet and outlet valves (9,10), while the admission pressure input by the driver is analyzed by means of the pressure sensor (3) in the brake system.

### BACKGROUND OF THE INVENTION

The invention relates to an electronic control method for a slip-controlled motor vehicle brake system, featuring a distributor device with an electronic unit (ECU) and hydraulic unit (HCU) comprising a housing body for hydraulic components, in particular, electrohydraulic inlet and outlet valves for wheel brakes organized in brake circuits, and with a motor-pump-aggregate with an electric motor, in particular, for redirecting hydraulic fluid from wheel brakes in the direction of a pressure sensor, wherein antilock control is facilitated through the build-up, maintenance and release of pressure in the electrohydraulic inlet and outlet valves, while the admission pressure input by the driver is analyzed by means of the pressure sensor in the brake system.

During ABS-control processes, electronically controlled motor vehicle brake systems of the prior art suffer from the disadvantage that, resulting from the operation of a so-called return pump as well as from the valve opening and valve closing processes, pressure pulsations appear, leading to excessive noise and, as a consequence thereof, to more or less pronounced reductions in passenger comfort.

On way of improving this situation is through the use of valves that facilitate reduced noise emission. In this respect, the use of so-called analog adjustable seat valves appears to have promise. To improve the noise behavior, an analogue triggering of the valve should be facilitated to some extent, in particular, through analogue adjustable zero-current open inlet valves (AD-/SO-valves). In this way, the analysis of a physical connection between a valve opening cross section in the valve body of the valve in connection with the pressure differential acting on the valve body as well as the induced voltage in an electrical valve coil is utilized (I˜Δp_{Ventil}). The noise reduction is achieved as follows. To facilitate a defined-calm pressure build-up gradient during a valve opening process, the coil current of the wheel inlet valve is adjusted depending on the pressure differential at the valve unit in such a way that an opening gap on the valve body first allows a regulated choke effect, and only then following opening position. In contrast to valves of the prior art, no abrupt valve opening occurs. The described choke effect prevents high and hence noise-intensive pressure build-up gradients. The noise level is thereby reduced. High pressure differentials at the valve body require a relatively high residual current in the valve coil to limit the pressure gradient on the valve body to an adequate level through the activated choke effect.

Because the pressure differential present at the valve body varies as a function of the operating states, pressure sensors are provided at both sides of the valve body for the measurement thereof (p_{THZ},p_{Rad}). The pressure input by the driver into a brake circuit upstream from the inlet valve for building the pressure differential can thereby be compared with the actual pressure on the wheel brake. Based on this realization, the coil current required for the reduced-noise pressure build-up control can be precisely determined and the pressure build-up gradient can be precisely adjusted accordingly. It is understood that, in addition to a reduced-noise control of pressure build-up, other applications are possible. An ABS-system for executing the described process requires at least four pressure sensors around the wheel brakes and at least one pressure sensor for measuring the pressure input by the driver as well as involved data processing.

### SUMMARY OF THE INVENTION

The aim of the invention is to provide a process that allows a sufficiently exact estimation of the pressure differential on the valve body without involved measurement of pressure. In other words, an object of the present invention is to facilitate a reduced-noise operation of the brake system and, in particular, to reduce the number of pressure sensors required in the brake system.

The aim of this invention can be achieved by having the electronic unit power the motor with modulated starting and/or shut-off phases in order to control rotational speed, wherein a generator voltage generated by the motor is tapped during a shut-off phase and fed to the electronic unit, which estimates the admission pressure present in the brake system based on the measured generator voltage to facilitate a reduced-noise triggering of the electrohydraulic inlet and outlet valves. In the context of this application, modulated motor triggering should always be understood to mean PWM-triggering.

The invention is based on the idea that a change in rotational speed (reduction of rotational speed) experienced by the motor-pump-aggregate during a shut-off phase of the motor can be used as a gauge for the system admission pressure and that the thereby derived information and realizations can be used for reduced-noise control of the electromagnetic valves. The change in rotational speed is simply measured by means of the generator voltage yielded. According to the invention, neither a motor rotational speed sensor nor a pressure sensor is necessary around the main brake cylinder.

In an advantageous configuration of the invention, the tapped generator voltage is examined in a defined time interval and analyzed to evaluate the coasting behavior of the motor-pump-aggregate. It has been demonstrated that the metrological determination of the generator voltage within the predetermined time interval is sufficient to facilitate a reduced-noise dedicated control of the electrohydraulic valve.

In a preferred control method, the coasting behavior of the motor-pump-aggregate is evaluated solely through the analysis of the degree of generator voltage gradient within the defined time interval. In this way, the influence of measurement errors, outliers or other short-term disturbances in the voltage are limited, and relevant, quantified information is facilitated.

Furthermore, the invention utilizes the surprisingly simple yet previously unrecognized relationship that states that—assuming constant ancillary conditions, such as the filling level of a pressure medium accumulator situated in the suction tract of the pump—the degree of the rotational speed gradient increases proportionally with admission pressure. In other words, the rotational speed of the motor-pump-aggregates is more quickly decelerated during a shut-off phase when a high admission pressure is present than when a low admission pressure is present. These considerations are based on the assumption that ancillary conditions are constant.

To improve the quality of the control, it is proposed to observe the pulse width of the electrical staring phases and/or shut-off phases, wherein for the tapping of the generator voltage shut-off phases are selected that share equal pulse width with one or more neighboring starting phases and/or shut-off phases. Through this and through und incidentally present, nearly constant ancillary conditions—such as, for example, a stationary brake actuation—it is ensured that a sufficiently stabilized rotational speed of the motor-pump-aggregate is present at the start of the applicable interval.

### BRIEF DESCRIPTION OF THE DRAWINGS

Further details of the invention can be found in the description and the drawings. The drawings schematically illustrate the following:

FIG. 1 a motor vehicle brake system with only one wheel brake circuit illustrated,

FIG. 2 rotational speed trends n_{MPA} of a motor-pump-aggregate (MPA) each at different pumping pressures,

FIG. 3 graph of pulse-width modulating starting- and shut-off phases of the motor-pump-aggregate for the purpose of controlling rotational speed of motor,

FIG. 4 tapped generator voltage trends U_{off} during a shut-off phase until standstill of the motor-pump-aggregate, each as a function of different pumping pressures,

FIG. 5 a graph showing the interdependences between onboard voltage U, terminal voltage Uₒₙ, generator voltage U_{off} and rotational speed n of a motor-pump-aggregate,

FIG. 6 a graph of terminal voltage Uₒₙ and generator voltage U_{off} during an interval Δt, and

FIG. 7 a graph showing the interdependences between U and pressure increase Δp.

### DETAILED DESCRIPTION OF THE DRAWINGS

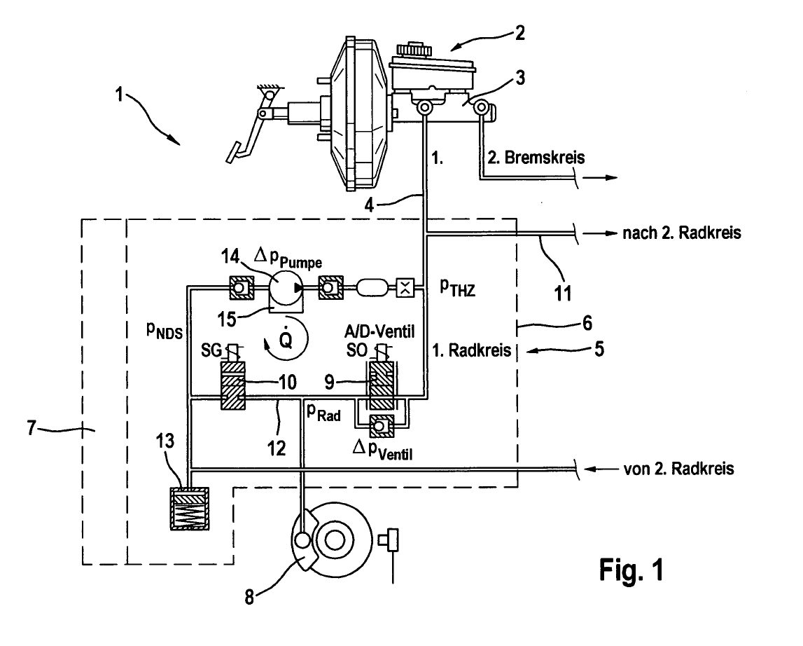

FIG. 1 illustrates an example of a brake circuit of a slip-controlled motor vehicle brake system 1, wherein only one wheel brake circuit is illustrated. The brake system 1 comprises a braking device with a hydraulic pressure sensor 3 in the form of a main brake cylinder, which is connected to a wheel brake 8 via a hydraulic connection 4 and a distributor device 5 comprising a hydraulic unit 6 and an electronic unit 7. The hydraulic unit 6 possesses a housing body for hydraulic and electrohydraulic components such as electromagnetically actuated inlet and outlet valves 9,10 for each wheel brake 8. In the connection—still upstream from a zero-current opened inlet valve for said wheel brake—is a branch 11 to a second wheel brake circuit. Projecting from the wheel brake 8, a return connection 12 leads via the zero-current closed outlet valve 10 to a low pressure accumulator 13, which can take up a volume discharged from the wheel brake 8 following ABS-control cycles. The low pressure accumulator 13 feeds a suction side of a motor-driven pump 14. This is preferably a radial piston pump and features a suction valve on the suction side and a pressure valve on a pressure side. Motor 15 and pump 14 are designed as an aggregate (motor-pump-aggregate=MPA) and allow a redirecting of discharged hydraulic fluid in the direction of the pressure sensor 3. It is thereby facilitated that a brake pedal at constant brake actuation during an ABS-control essentially remains at its place and does not fail. It is understood that the brake system can feature an additional range of functions such as, for example, an anti-slip control (ASR) or an electronic stability program (ESP), which requires an electromagnetically triggered, zero-current opened isolation valve connected in series to the inlet valve 9.

The following description is made based on an example of reduced-noise control of A/D-inlet valves 9, wherein further applications are possible without going beyond the scope of the invention. For example, it is possible to use the information gathered for estimating the filling level of low pressure accumulators to trigger the pump only exactly as long as is needed to empty the low pressure accumulator. In this way, the creation of excessive noise or irritation of the driver is prevented. A completely empty low pressure accumulator is advantageous, for example, when an EBD control intervention (EBD=electronic brake force distribution) is necessary, wherein a certain volume from the wheel brakes of a rear axle should be taken up by the low pressure accumulators. The return pump can thereby—depending on the filling level of the accumulator—facilitate the emptying of the low pressure accumulator.

During an ABS-control, a pressure differential (Δpᵥₐₗᵥₑp_{THZ}−p_{wheel}) appears at the inlet valve SO, 9 resulting from pressure release processes via the outlet valve SG, 10. The volume escaping from the wheel brake 8 enters the low pressure accumulator 13, LPA. At the same time the pump 14 is activated and pumps the discharge volume—against the driver admission pressure following brake actuation—back into the direction of the pressure sensor 3 and upstream from the inlet valve 9. In this situation, the applied driver admission pressure creates a resistance that acts upon the output current of the pump. With increasing pressure differential between pressure sensor 3 and wheel brake 8 (Δpₚᵤₘₚ≈p_{THZ}) the resistance increases, and the pumped volume flow (\dot{V}) decreases under constant pumping action Pₚᵤₘₚ and increasing pressure differential ΔPₚᵤₘₚ. This interdependence is expressed in the following relationship:
Pₚᵤₘₚ=ΔPₚᵤₘₚ·\dot{V}=Δpₚᵤₘₚ·n·V_{H} (1)

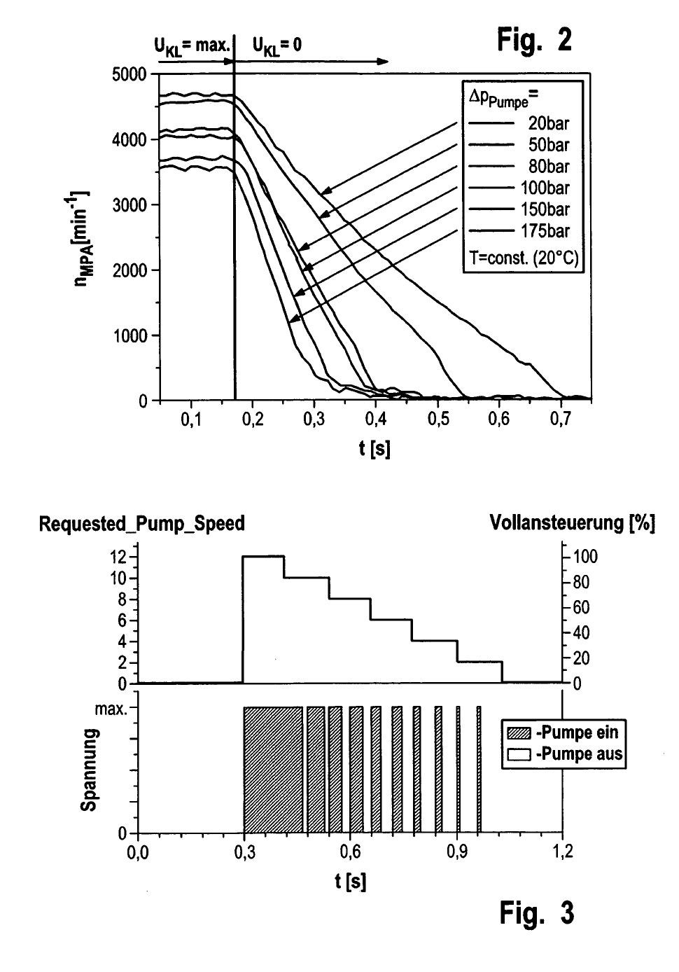

FIG. 2 illustrates the interdependence between the rotational behavior of the motor-pump-aggregate with rising pressure increase at constant temperature, and is subdivided into a starting phase (UKL=max.) and a shut-off phase (UKL=0). It is to taken into consideration that a rigid coupling prevails between the motor and pump, so that the rotational speed of the motor is equal to the rotational speed of the pump.

Assuming a minor leakage loss, the rotational speed n of the motor-pump-aggregate (MPA) decreases according to (1) at equal applied output P with rising pressure increase Δp_{Pumpe}. In other words, the maximum rotational speed of the motor-pump-aggregate is inversely proportional to the pressure increase.
n_{MPA,max}˜1/Δpₚᵤₘₚ (2)

As FIG. 2 illustrates, this also applies to the coasting behavior of the motor-pump-aggregate within a shut-off phase starting at the point in time UKL=0. The degree of rotational speed change per unit of time—that is the rotational speed gradient—increases with rising pressure increase Δp_{Pumpe}.

$$\vert \frac{Δ {n}_{MPA}}{Δ t} \sim Δ {p}_{Pumpe} \qquad ( 3 )$$

As the following explanations demonstrate, the described interdependences are utilized to create a pressure model through evaluation of information equivalent to rotational speed, thereby facilitating reduced-noise control. For designing the model, a discrete measurement of pressure values can be bypassed by accessing the electrical parameters of the motor that are proportional to rotational speed when the generator is in operation, such as, in particular, the gradient of generator voltage, which behaves proportionally to the gradient of motor rotational speed.

The electric motor 15 of the pump 14 is based in principle on a separately excited d.c. machine—in particular a permanent magnet-excited communicator machine—the rotational speed of which is controlled via a pulse width modulation (PWM) of a constant terminal voltage UKL. For controlling rotational speed, the duration of starting- and shut-off phases is modulated in steps within a fixed interval (e.g. T=60 sec) according to rotational speed specification (=requested_pump_speed). FIG. 3 illustrates a 12-step rotational speed control, wherein a full modulation of 100% corresponds to a so-called requested_pump_speed of 12 with a starting phase over the entire aforementioned interval. Beginning at requested_pump_speed<=10 the motor 15 is controlled through modulation. The armature voltage is cyclically interrupted. With decreasing requested_pump_speed, the pulse width of the shut-off phases (motor off) increases, while the pulse width of the starting phase (motor on) decreases.

Controlling the rotational speed of the motor 15 in ABS operation (and therefore the output of the pump 14) is performed as a function of calculated volume flow rate or rather of filling level of the low pressure accumulators 13 (LPA-model). The pulse-width-modulated terminal voltage (UKL) is generated as a controller signal by means of an analog-digital-converter. In the PWM starting phase this signal corresponds roughly to the maximum available onboard voltage in the motor vehicle. During a PWM shut-off phase the motor 15 functions as a generator, however, and a generator voltage U can be tapped from carbon brushes, the amplitude of which can provide information on the rotational speed level. For evaluating the relationship
U_{A}=C_{Masch}·Φ·n+R_{A}·I_{A} (4)
the following assumptions are made: 1. The portion of the armature voltage (I_{A}) during generator operation is minor and can therefore be disregarded. 2. As construction-related influence parameters, the exciter flow (Φ) and motor constant (C_{Masch}) are constant, so that in the equation (4), rotational speed n and generator voltage U are proportional when the generator is operated:
n_{MPA}˜U_{MPA,Off}

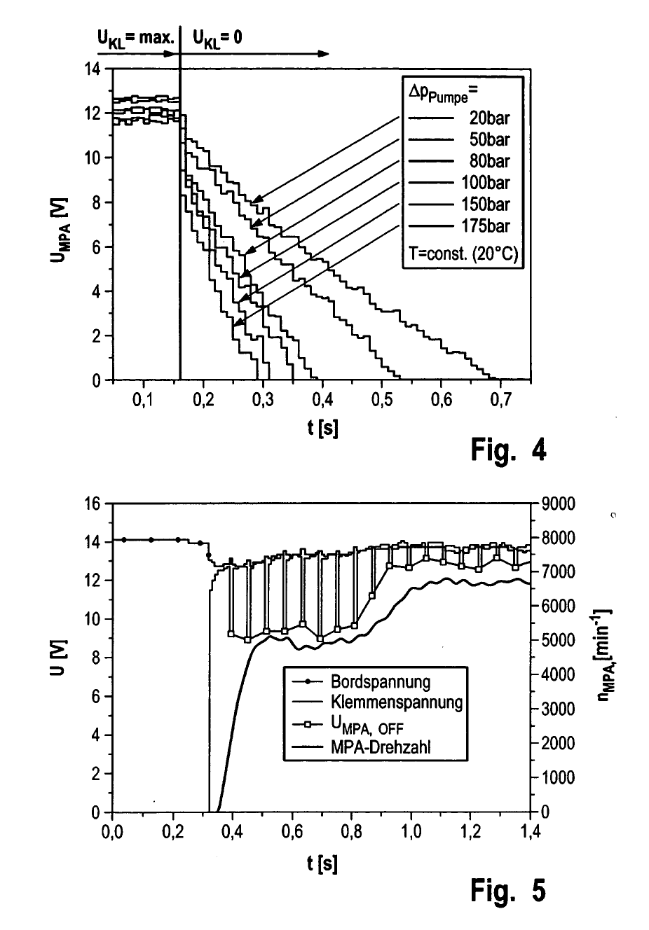

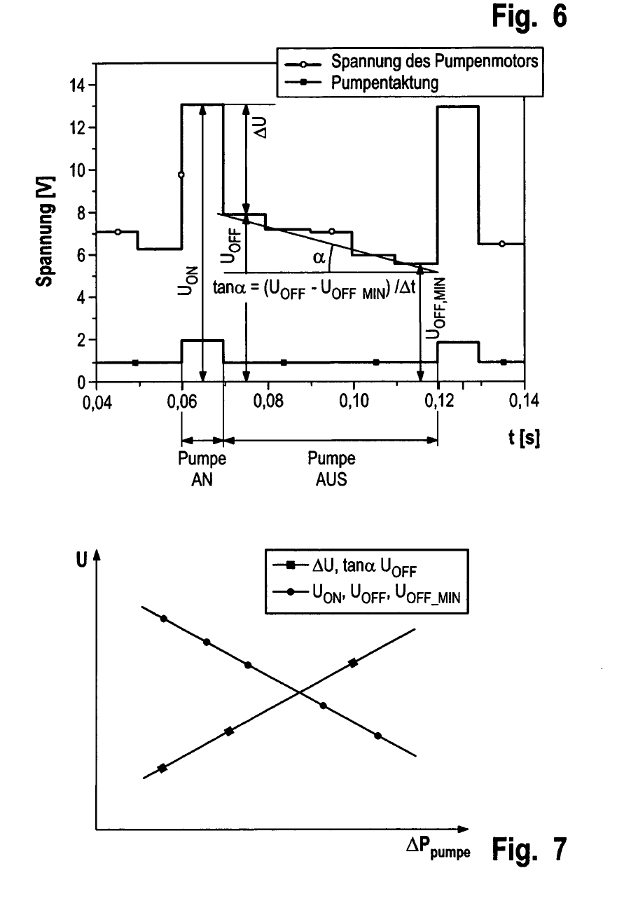

The relationship above is confirmed in FIG. 4, in which the voltage U is plotted against time t. Generator voltage is a direct function of the rotational speed of the motor 15 in a first unenergized loop (a certain partial interval of the 60 ms interval listed above). The rotational speed of the motor is in turn influenced by driver admission pressure and the thereby exerted pump force. With rising driver admission pressure, the pump works against increased resistance, and the rotational speed as well as the associated generator voltage that can be tapped u_{off} decrease. Because uₒₙ as well as u_{off} are a function of pressure, the difference Δu=uₒₙ−u_{off} takes on characteristic, quasi-proportional values for different admission pressures. The voltage difference behaves proportionally to driver admission pressure or rather to the pressure increase to be applied. A value u_{off} min corresponds to generator voltage in a last unenergized loop of a shut-off phase of the motor 15.

From the values u_{off}, u_{off} min and the time Δt, the pressure-dependant gradient of the generator voltage can be calculated using

$$tan α {U}_{OFF} = \frac{{U}_{OFF} - {U}_{OFF MIN}}{Δ t}$$

To yield the most relevant information for reduced-noise control, the following ancillary conditions should be taken into consideration.
Changes in rotational speed of the pump: In the case of frequently changed modulation of the PWM-starting and shut-off phases (requested_pump_speed), only short phases of a steady-state, constant rotational speed level exist. This leads to a diminishment of the data pool that can be analyzed and thereby decreased model quality. The PWM-modulation to be taken into consideration should be characterized with nearly identical modulation through repeated intervals.
Pump load: As a function of the pumping state of the pump 14 (pumping into 2 brake circuits, pumping into one brake circuit or emptying) various forms of motor strain appear, leading to corresponding changes in rotational speed and voltage patterns. Because the difference between these load degrees is striking, however, these are visible and should be factored into the analysis—for example against the sum of collected values.
Temperature: The decreasing kinematic viscosity of the brake fluid with rising temperature leads to the fact that, as temperatures rise, the fluid becomes increasingly thinner and a smaller load torque is produced on the pump than would be found with viscous brake fluid resulting from colder temperatures. The smaller load torque leads to higher rotational speeds and thereby to minor drops in voltage. The temperature influence is visible and is to be taken into consideration.

The inversely proportional relationship between the values uₒₙ, u_{off}, _{uoff}_{_{—}}min and pressure increase Δp as well as the proportional relationship between the generator voltage gradient tan α u_{off} and the pressure increase Δp are illustrated in FIG. 7.

1-8. (canceled)

9. A control method for a slip-controlled motor vehicle brake system (1) having a distributor device (5) with an electronic unit (7, ECU) and a hydraulic unit (6, HCU) having a housing body for hydraulic elements including electrohydraulic inlet- und outlet valves (9,10) for wheel brakes (8) organized in brake circuits, and with a motor-pump-aggregate with electric motor (15), in particular, for redirecting hydraulic fluid from wheel brakes (8) in the direction of a pressure sensors (3), wherein an antilock control is facilitated through the build-up, maintenance and release of pressure in the electrohydraulic inlet and outlet valves (9, 10), while the admission pressure input by the driver is analyzed by means of the pressure sensor (3) in the brake system, the method comprising:
using an electronic unit to supply a motor with at least one of a defined electrical starting and shut-off phases in order to control rotational speed of the motor;
generating a generator voltage when the motor is tapped during a shut-off phase;
feeding the generator voltage to the electronic unit in order to estimate an admission pressure present in the brake system based on the generator voltage; and
facilitating a reduced-noise triggering of one or more electrohydraulic valve.

10. The method according to claim 9, wherein a tapped generator voltage is examined in a defined time interval and analyzed to evaluate a coasting behavior of a motor-pump-aggregate, and from the evaluated coasting behavior, the admission pressure load of the motor-pump-aggregate is determined.

11. The method according to claim 10, wherein the coasting behavior of the motor-pump-aggregate is evaluated through the analysis of a degree of generator voltage gradient within the defined time interval.

12. The method according to claim 11, wherein the time interval is defined through the equation Δt=a*loop time−t_{starting phase}, with a equaling a constant.

13. The method according to claim 12, wherein the loop time=10 ms, a=6 and t_{starting phase}=30 ms.

14. The method according to claim 12, wherein the time interval is calculated by t_{starting phase}<A*loop time.

15. The method according to claim 9, wherein the generator voltage gradient is proportional to the rotational speed gradient.

16. A method according to claim 9, wherein the rotational speed gradient increases proportionally with admission pressure when the generator is operated.

17. A method according to claim 9, wherein pulse widths of the electric starting phases are examined, and for the tapping of generator voltage, shut-off phases are selected that that share equal pulse width with one or more neighboring starting phases.

18. A method according to claim 9, wherein pulse widths of the electric shut-off phases are examined, and for the tapping of generator voltage, shut-off phases are selected that that share equal pulse width with one or more neighboring shut-off phases.
